(19) United States
(12) Patent Application Publication
(10) Pub. No.: US 2026/0019897 A1
(43) Pub. Date: Jan. 15, 2026

(54) METHODS, ARCHITECTURES, APPARATUSES AND SYSTEMS FOR CELL SELECTION AND RESELECTION WITH MULTIPATH OPERATIONS AND SIDELINK RELAYS

(71) Applicant: InterDigital Patent Holdings, Inc., Wilmington, DE (US)

(72) Inventors: Oumer Teyeb, Montreal (CA); Martino Freda, Laval (CA); Tuong Hoang, Montreal (CA); Ananth Kini, Conshohocken, PA (US)

(21) Appl. No.: 18/993,734

(22) PCT Filed: Jul. 13, 2023
(86) PCT No.: PCT/US2023/027606

§ 371 Date: Jan. 13, 2025

Related U.S. Application Data
(60) Provisional application No. 63/388,936, filed on Jul. 13, 2022.

(51) Int. Cl. H04W 36/00; H04B 17/318; H04W 72/25

(52) U.S. Cl. CPC H04W 36/0085; H04B 17/328; H04W 36/0077; H04W 72/25

(57) ABSTRACT

Procedures, methods, architectures, apparatuses, systems, devices, and computer program products for cell selection and/or cell selection, such in multipath operation environments. For example, a wireless transmit/receive unit (WTRU) may receive information indicating (e.g., whether or not) serving cells and/or neighbor cells provide multipath operation. Multipath may refer to scenarios where a remote WTRU connects to a network via a direct (e.g., Uu interface) path and an indirect (e.g., PCS interface) path. In an example cell selection procedure, a remote WTRU may evaluate a serving cell based on criteria which may depend on any of multipath availability and/or sidelink measurements with respect to a candidate relay WTRU. In an example cell reselection procedure, a remote WTRU may evaluate a neighbor cell based on criteria which may depend on any of multipath availability and/or sidelink measurements with respect to a candidate relay WTRU.

### CROSS-REFERENCE TO RELATED APPLICATIONS

This application claims the benefit of U.S. Provisional Patent Application No. 63/388,936 filed 13 Jul. 2022, which is incorporated herein by reference.

### TECHNICAL FIELD

The present disclosure is generally directed to the fields of communications, software and encoding, including, for example, to methods, architectures, apparatuses, systems directed to cell selection and/or reselection procedures which may consider multipath connections and sidelink relays.

### BACKGROUND

In 5G New Radio (NR), a wireless transmit/receive unit (WTRU) may perform cell selection to determine a suitable cell. The WTRU may perform cell ranking to determine a highest ranked cell. Solutions which consider the availability of multipath opportunities at the WTRU when performing cell selection and/or reselection are desirable.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a flow diagram illustrating an example overview of the states and state transitions and procedures in RRC_IDLE and RRC_INACTIVE for 5G New Radio (NR);

FIG. 3 is a system diagram illustrating an example of cell selection in an example communications system;

FIG. 4 is a procedural diagram illustrating an example procedure for cell selection;

FIG. 5 is a procedural diagram illustrating an example procedure for cell ranking;

FIG. 6 is a procedural diagram illustrating an example procedure for cell selection and/or ranking based on multipath operation;

FIG. 7 is a procedural diagram illustrating another example procedure for cell selection and/or ranking based on multipath operation; and

FIG. 8 is a procedural diagram illustrating an example procedure for cell selection and/or ranking a first cell among a set of cells.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

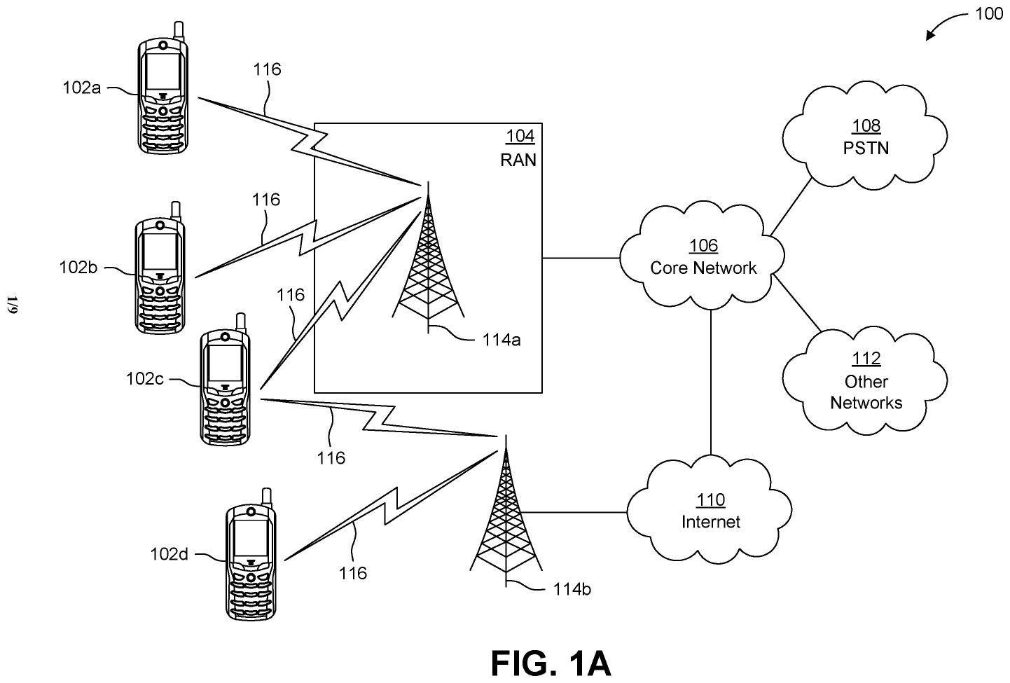

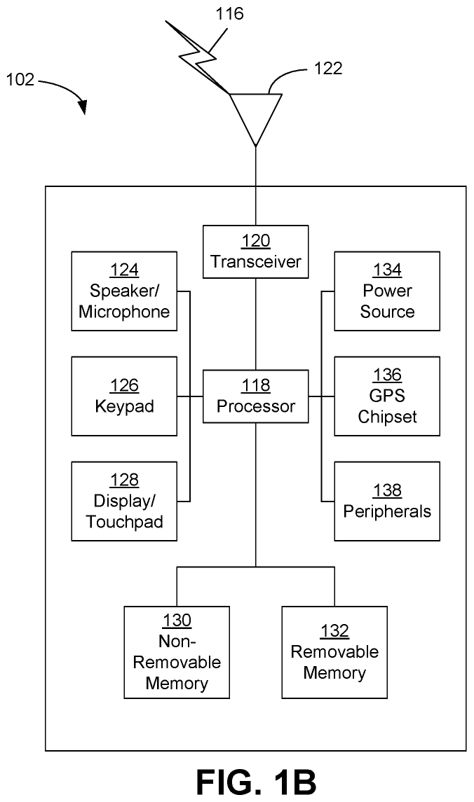

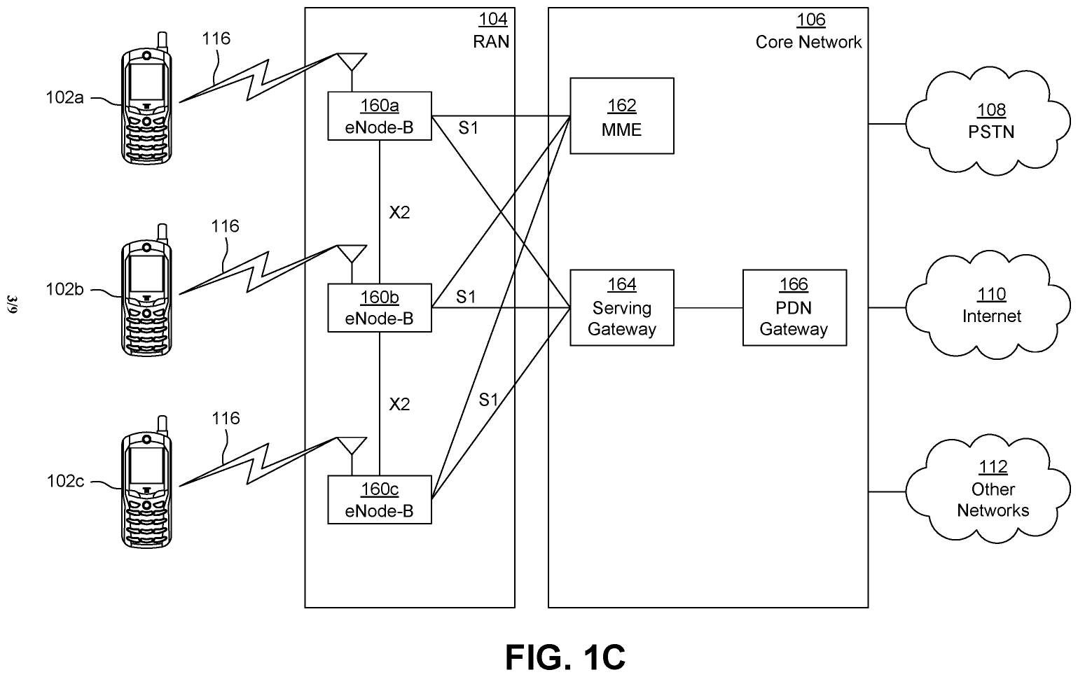

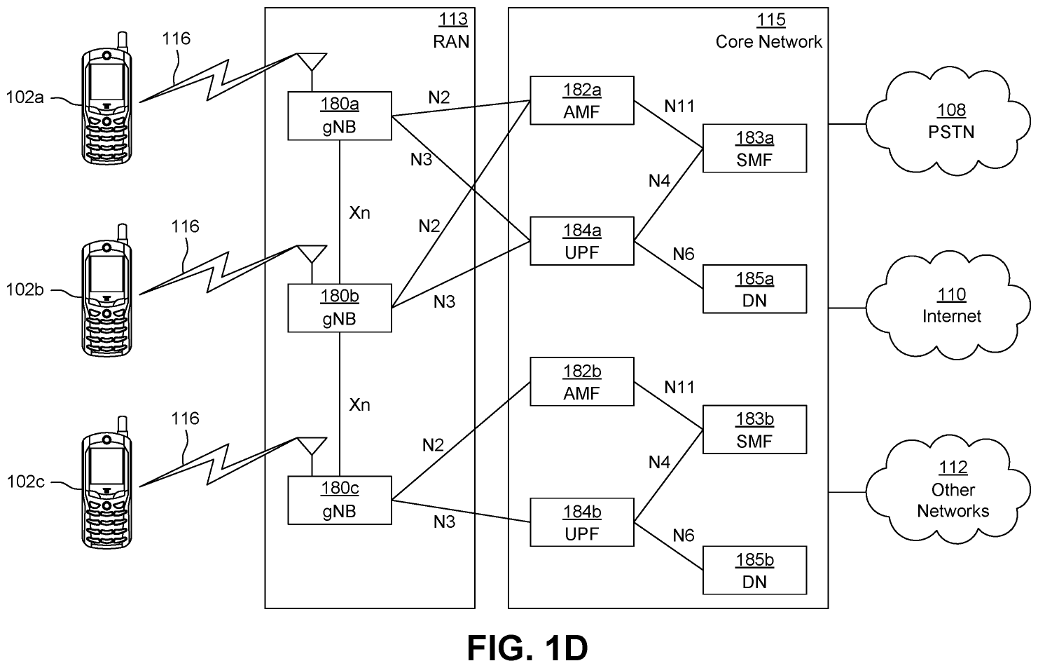

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### WTRU-to-Network Relays

### Sidelink (SL) Relaying

Relaying via (e.g., ProSe) WTRU-to-Network relays was introduced in 3GPP Release 13 to extend network coverage to an out of coverage WTRU 102 by using a PC5 interface (e.g., a device to device connection) between an out of coverage WTRU 102 and a WTRU-to-Network relay (e.g., a relay WTRU 102).

For 3GPP Release 16, a first version of NR SL has been developed and with a (e.g., sole) focus on supporting vehicle-to-everything (V2X) related road safety services. The V2X design aims to provide support for broadcast, groupcast and unicast communications in both out-of-coverage and in-network coverage scenarios. SL-based relaying functionality should be additionally studied in order for SL and/or network coverage extension and power efficiency improvement, considering a wider range of applications and services.

To further explore coverage extension for sidelink-based communication, WTRU-to-network coverage extension and WTRU-to-WTRU coverage extension are two possible scenarios. In WTRU-to-network coverage extension, Uu coverage reachability may be necessary for WTRUs 102 to reach a server in a PDN network or a counterpart WTRU in an out of proximity area. However, Release 13 solutions on WTRU-to-network relays are limited to EUTRA-based technology, and may not be applicable to NR-based system, for both NG-RAN and NR-based sidelink communication. In WTRU-to-WTRU coverage extension, the current proximity reachability may be limited to a single-hop SL link, either via EUTRA-based or NR-based sidelink technology. This may not be sufficient in scenarios where there is no Uu coverage, considering the limited coverage of single-hop SL.

Sidelink connectivity was further extended in the NR framework in order to support enhanced QoS requirements. In 3GPP Release 17, single hop NR SL relays were introduced with the following main objectives:
1. Study mechanism(s) with minimum specification impact to support the SA requirements for sidelink-based WTRU-to-network and WTRU-to-WTRU relays, focusing on the following aspects (if applicable) for layer-3 (L3) relaying and layer-2 (L2) relaying:
   Relay (re-)selection criterion and procedure;
   Relay/Remote UE authorization;
   QoS for relaying functionality;
   Service continuity;
   Security of relayed connection after SA3 has provided its conclusions; and
   Impact on user plane protocol stack and control plane procedure, e.g., connection management of relayed connection.
2. Study mechanism(s) to support upper layer operations of discovery model/procedure for sidelink relaying, assuming no new physical layer channel/signal [RAN2].

For example, a L2 WTRU-to-network relay WTRU may be configured by a gNB 180 with a local Remote WTRU ID. A Remote WTRU 102 may obtain the local Remote ID from the gNB 180 via Uu RRC messages, such as any of RRCSetup, RRCReconfiguration, RRCResume and/or RRCReestablishment. Uu DRB(s) and Uu SRB(s) may be mapped to different PC5 Relay RLC channels and Uu Relay RLC channels for any of a PC5 hop and/or a Uu hop.

Multipath Operation with SL Relays

3GPP has agreed to continue the enhancements of the NR SL relay specification in Release 18, with specification work expected to start in August 2022. One of the features that is planned be discussed is the support of multi-path with relays, where a remote WTRU 102 is connected to a network via direct and indirect paths. Multipath operation has the potential to improve the reliability, robustness and/or throughput of wireless communications.

For example, multi-path relaying may be utilized for WTRU aggregation where a WTRU 102 is connected to a network via a direct path and an indirect path, such as via another WTRU using a (e.g., non-standardized) WTRU-WTRU interconnection. WTRU aggregation aims to provide applications requiring high UL bitrates on 5G terminals, such as in cases when normal (e.g., non-multipath) WTRUs are too limited by UL transmission power to achieve a required or desired bitrate, such as during operation at the edges of a cell. Also, WTRU aggregation may improve the reliability, stability, and/or reduce delay of services as well. As an example, in situations where channel conditions of a WTRU 102 are deteriorating, another WTRU 102 may be used to make up for the traffic performance unsteadiness caused by channel condition variations.

Multipath operation is planned as one of the core objectives of Release 18. Studies are planned as to the benefits and potential solutions for multipath support to enhance reliability and throughput (e.g., by switching among or utilizing the multiple paths simultaneously) in scenarios such as where a WTRU 102 is connected to a same gNB 180 using one direct path and one indirect path via 1) Layer-2 UE-to-Network relay, or 2) via another WTRU (e.g., where the WTRU-WTRU inter-connection is assumed to be ideal). These solutions for 1) are ideally to be reused for 2) without precluding the possibility of excluding a part of the solutions which are unnecessary for the operation for 2).

### SL Measurements and Scheduling

In SL operation, a WTRU 102 may be configured with an associated peer WTRU 102 to perform NR sidelink measurement and report on the corresponding PC5-RRC connection. For example, the reporting may be made in accordance with a NR SL measurement configuration for unicast, such as by a RRC ReconfigurationSidelink message.

For example, a WTRU 102 may (e.g., shall) derive NR sidelink measurement results by measuring one or more DMRSs associated per PC5-RRC connection which may be configured by the associated peer WTRU 102. For (e.g., all of) the NR sidelink measurement results, the WTRU 102 may apply L3 filtering before using the measured results for evaluation of reporting criteria and measurement reporting. In Release 16, only NR sidelink RSRP can be configured as a trigger quantity and a reporting quantity. The following measurement events are defined for NR sidelink:
Event S1 (Serving becomes better than a threshold); and
Event S2 (Serving becomes worse than a threshold).

The S1 and S2 based measurement (e.g., reports) may be used by the WTRU 102 receiving the report to adjust a power level when transmitting data. For example, NR SL transmissions have the following two modes of resource allocations:
Mode 1: Sidelink resources are scheduled by a gNB 180; and
Mode 2: The WTRU 102 autonomously selects SL resources from a (pre) configured SL resource pool(s) based on the channel sensing mechanism.

For in-coverage WTRUs 102, the WTRUs may be configured to operate in Mode 1 or Mode 2. For out-of-coverage WTRUs 102, the WTRUs may be configured to operate in (e.g., only) Mode 2.

To enhance the QoS of NR sidelink transmissions, congestion control may be important, such as in Mode 2, to prevent a transmitting WTRU from occupying too many resources in SL transmissions. For example, two metrics may be defined as follows:
Channel Busy Ratio (CBR): A portion of subchannels whose received signal strength indicator (RSSI) exceeds a (pre) configured value over a certain time duration; and
Channel Occupation Ratio (CR): For a slot ‘n’, the CR may be determined as (X+Y) M, where ‘X’ is the number of the subchannels that have been occupied by a transmitting WTRU within slots [n−a, n−1], ‘Y’ is the number of the subchannels that have been granted within slots [n, n+b], and ‘M’ is the total number of subchannels within slots [n−a, n+b].

For congestion control, an upper bound of the CR may be denoted as CRₗᵢₘᵢₜ and which may be imposed to a transmitting WTRU 102. For example, the CRₗᵢₘᵢₜ may be a function of CBR and the priority of the SL transmissions. In certain representative embodiments, the amount of resources occupied by a transmitting WTRU 102 may not exceed CRₗᵢₘᵢₜ.

A CBR report may be used by a gNB 180 to determine the (e.g., SL) pool of resources allocated to SL communication (e.g., increase the pool of resources if the WTRUs involved in sidelink communication are reporting high CBRs, decrease the pool of resources if the CBRs reported are low).

In addition to peer WTRUs involved in SL operation configuring each other for measurement (e.g., periodical and/or S1, S2 events), for in-coverage operation (e.g., the remote WTRU 102 is within the coverage of the gNB 180), the gNB 190 can configure the remote WTRU 102 with CBR measurements, which may also be either periodical or event triggered. The following two measurement events may be configured for CBR measurement reporting:
Event C1 (CBR of NR sidelink communication becomes greater than absolute threshold); and
Event C2 (CBR of NR sidelink communication becomes less than absolute threshold).

### Mobility in (Uu) RRC_IDLE and RRC_INACTIVE

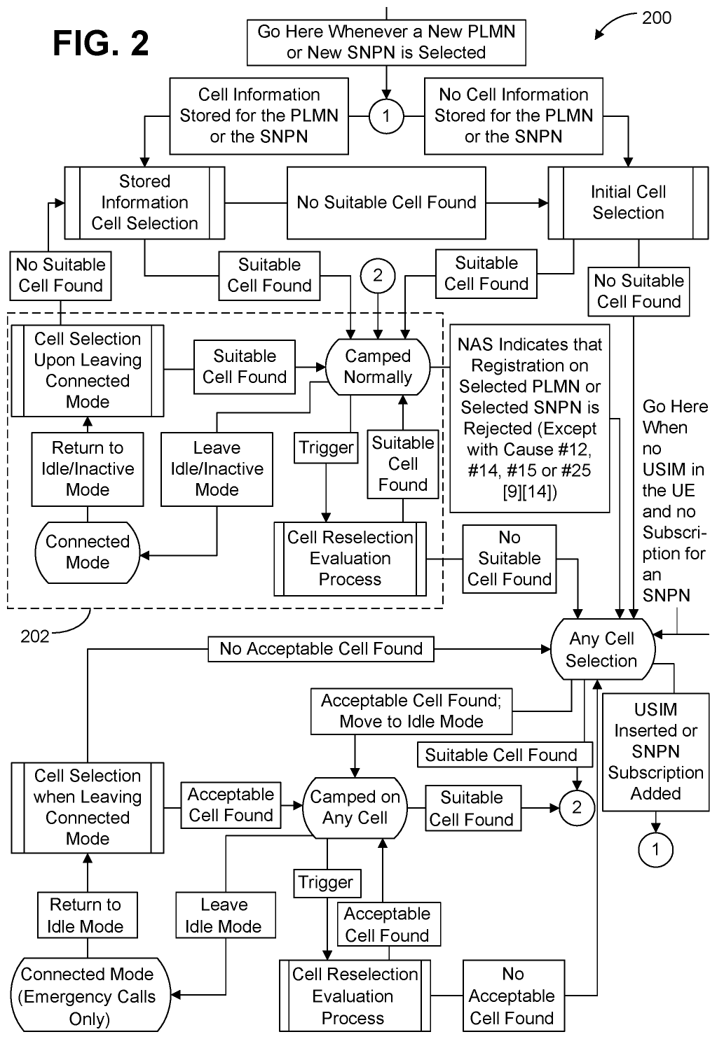

FIG. 2 is a flow diagram illustrating an example overview 200 of the states and state transitions and procedures in RRC_IDLE and RRC_INACTIVE for 5G NR as described in 3GPP TS 38.304. Those skilled in the art should be familiar with the flow depicted in FIG. 2 and details of the overview 200 are omitted. In certain representative embodiments, a (e.g., remote) WTRU 102 may perform procedures which relate to transitioning between one or more connection states. For example, a WTRU 102 may perform procedures related to going from may RRC_CONNECTED to RRC_IDLE and/or RRC_INACTIVE (e.g., upon the reception of an RRC Release message and/or transitory cell selection done during RRC Re-establishment), such as where the WTRU 102 is able to find a suitable cell to camp on. As highlighted in the portion 202 in FIG. 2, a WTRU 102 may perform cell selection upon leaving connected mode (e.g., RRC_CONNECTED) and/or may perform a cell reselection evaluation process after being camped normally. For example, the RRC Release message may include an inactive radio network temporary identifier (I-RNTI) for the WTRU 102.

In certain representative embodiments, the cell selection procedure upon leaving connected mode and/or the cell reselection evaluation process in portion 202 may be modified as described herein.

### Cell Selection

In certain representative embodiments, a WTRU 102 may search frequency bands (e.g., NR frequency bands). For each carrier frequency, the WTRU 102 may identify a strongest cell as per a cell defining synchronization signal block (CD-SSB). The WTRU 102 may then obtain cell system information broadcast to identify its PLMN(s) to find a suitable cell to camp on. For example, a suitable cell may be a cell for which (1) the measured cell attributes satisfy cell selection criterion, (2) the cell PLMN is the selected PLMN, registered or an equivalent PLMN, (3) the cell is not barred or reserved, and/or (4) the cell is not part of a tracking area (TA) which is in the list of “forbidden tracking areas for roaming”.

On transition from RRC_CONNECTED and/or RRC_INACTIVE to RRC_IDLE, a WTRU 102 may (e.g., should) camp on a cell as result of cell selection according to the frequency being assigned by RRC in the state transition message (e.g., if any is provided).

In certain representative embodiments, the cell selection criteria, which may be referred to as criterion S, may be fulfilled when:

$$Srxlev > 0 ; and \qquad ( 1 )$$

$$Squal > 0 , \qquad ( 2 )$$

$$where :$$

$$Srxlev = {Q}_{rxlevmeas} - ( {Q}_{rxlevmin} + {Q}_{rxlevminoffset} ) - {P}_{compensation} {Qoffset}_{temp} ; \qquad ( 3 )$$

$$and$$

$$Squal = {Q}_{qualmeas} - ( {Q}_{qualmin} + {Q}_{qualminoffset} ) - {Qoffset}_{temp} . \qquad ( 4 )$$

The foregoing parameters may be defined as shown in the table below:

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained |
| | from q-RxLevMinSUL, if present, in SIB1, SIB2 and SIB4, |
| | additionally, if Q_{rxlevminoffsetcellSUL} is present in SIB3 and |
| | SIB4 for the concerned cell, this cell specific offset is |
| | added to the corresponding Qrxlevmin to achieve the |
| | required minimum RX level in the concerned cell; |
| | else Qᵣₓₗₑᵥₘᵢₙ is obtained from q-RxLevMin in SIB1, SIB2 |
| | and SIB4, additionally, if Q_{rxlevminoffsetcell} is present in SIB3 |
| | and SIB4 for the concerned cell, this cell specific offset is |
| | added to the corresponding Qrxlevmin to achieve the |
| | required minimum RX level in the concerned cell. |
| Q_{qualmin} | Minimum required quality level in the cell (dB). |
| | Additionally, if Q_{qualminoffsetcell} is signalled for the |
| | concerned cell, this cell specific offset is added to |
| | achieve the required minimum quality level in the |
| | concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122. |
| Q_{qualminoffset} | Offset to the signalled Q_{qualmin} taken into account in the |
| | Squal evaluation as a result of a periodic search for a |
| | higher priority PLMN while camped normally in a |
| | VPLMN, as specified in TS 23.122. |
| P_{compensation} | For FR1, if the UE supports the additionalPmax in the NR- |
| | NS-PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when |
| | transmitting on the uplink in the cell (dBm) defined as |
| | P_{EMAX} in TS 38.101. If UE supports SUL frequency for this |
| | cell, P_{EMAX1} and P_{EMAX2} are obtained from the p-Max for |
| | SUL in SIB1 and NR-NS-PmaxList for SUL respectively in |
| | SIB1, SIB2 and SIB4 as specified in TS 38.331, else P_{EMAX1} |
| | and P_{EMAX2} are obtained from the p-Max and NR-NS- |
| | PmaxList respectively in SIB1, SIB2 and SIB4 for normal |
| | UL as specified in TS 38.331. |
| P_{PowerClass} | Maximum RF output power of the UE (dBm) according to |
| | the UE power class as defined in TS 38.101-1. |

For example, the signaled values Q_{rxlevminoffset} and Q_{qualminoffset} may be (e.g., only) applied when a cell is evaluated for cell selection as a result of a periodic search for a higher priority PLMN while camped normally in a visiting public land mobile network VPLMN. During this periodic search for a higher priority PLMN, a WTRU 102 may check the criterion S of a cell using parameter values stored from a different cell of this higher priority PLMN.

### Cell Reselection

In certain representative embodiments, a (e.g., remote) WTRU 102 may perform procedures which relate to (e.g., transitioning between) one or more connection states. For example, a WTRU 102 may perform cell reselection procedures in RRC_IDLE and/or RRC_INACTIVE. As examples, a WTRU 102 may perform any of intra-frequency, inter-frequency or inter-RAT cell reselection.

For example, a WTRU 102 may be configured with priorities among RATs (e.g., prioritize camping on NR over LTE whenever an NR cell s available) or among frequencies within the same RAT (e.g., frequency fa has highest priority, frequency fb has medium priority, frequency fc has lowest priority, etc.). A neighbor cell list (NCL) may be provided to the WTRU 102, indicating which neighbor cells (e.g., intra-frequency, inter-frequency, inter-RAT) may (e.g., shall) be considered for cell reselection. Allow-lists may be provided to the WTRU 102 indicating the (e.g., only) neighboring cells that may be considered for reselection. Exclude-lists may be provided to the WTRU 102 indicating the neighboring cells that may (e.g., shall) not be considered for reselection.

In certain representative embodiments, a WTRU 102 may attempt to camp on a cell operating with a highest priority RAT and/or with a highest priority frequency.

For example, on condition that a serving cell fulfills Srxlev>S_{IntraSearchP} and Squal>S_{IntraSearchQ}, a WTRU 102 may determine not to perform intra-frequency measurements. Otherwise, the WTRU 012 may (e.g., shall) perform intra-frequency measurements.

For example, on condition that a serving cell fulfils Srxlev>S_{nonIntraSearchP} and Squal>S_{nonIntraSearchQ}, a WTRU 102 may choose not to perform measurements of NR inter-frequency cells of equal or lower priority and/or inter-RAT frequency cells of lower priority. Otherwise, the WTRU 102 may (e.g., shall) perform measurements of NR inter-frequency cells of equal or lower priority and/or inter-RAT frequency cells of lower priority.

For example, S_{IntraSearchP} may specify a Srxlev threshold (e.g., in dB) for intra-frequency measurements.

For example, S_{IntraSearchQ} may specify a Squal threshold (e.g., in dB) for intra-frequency measurements.

For example, S_{nonIntraSearchP} may specify a Srxlev threshold (e.g., in dB) for NR inter-frequency and/or inter-RAT measurements.

For example, S_{nonIntraSearchQ} may specify a Squal threshold (e.g., in dB) for NR inter-frequency and/or inter-RAT measurements.

In certain representative embodiments, a WTRU 102 may determine to perform intra-frequency, inter-frequency, and/or inter-RAT measurements for cell reselection. For example, cell reslection may be based on any of the criteria and/or parameters above. The WTRU 102 may perform cell ranking of the concerned cells.

In certain representative embodiments, the cell-ranking criteria, which may be referred to as criterion R, for a serving cell (Rₛ) and for any neighbouring cells (Rₙ) may be defined by:

$${R}_{s} = {Q}_{mean , s} + {Q}_{hyst} - {Qoffset}_{temp} ; and \qquad ( 5 )$$

$${R}_{n} = {Q}_{meas , n} - Qoffet - {Qoffset}_{temp} . \qquad ( 6 )$$

The foregoing parameters may be defined as shown in the table below:

| Qₘₑₐₛ | RSRP measurement quantity used in cell reselections. |
|---|---|
| Qoffset | For intra-frequency: Equals to Qoffset_{s, n}, if Qoffset_{s, n} is |
| | valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in TS |
| | 38.331. |

For example, a WTRU 102 may (e.g., shall) perform ranking of any (e.g., all) cells that fulfil the cell selection criterion S as described above.

For example, the cells may (e.g., shall) be ranked according to the criterion R described above by obtaining (e.g., determining or deriving) Q_{meas,n} and Q_{meas,s} and calculating the R values, such as by using averaged RSRP results.

In certain representative embodiments, on condition that a range ToBestCell (e.g., value) is not configured, a WTRU 102 may (e.g., shall) perform cell reselection to a highest ranked cell.

In certain representative embodiments, on condition that a range ToBestCell (e.g., value) is configured, a WTRU 102 may (e.g., shall) perform cell reselection to a cell with a highest number of beams above the threshold (e.g., absThreshSS-BlocksConsolidation) among the cells whose R values are within range ToBestCell of the R value of the highest ranked cell. For example, where there are multiple such cells, the WTRU 102 may (e.g., shall) perform cell reselection to the highest ranked cell among them.

In certain representative embodiments, a WTRU 102 may (e.g., shall) reselect the new cell, on condition that any (e.g., all) of the following are met:
the new cell is better than the serving cell according to the cell reselection criterion specified above (e.g., during a time interval, such as Treselection_{RAT}); and/or
more than 1 second has elapsed since the WTRU 102 camped on the current serving cell.

### Relay Discovery

Model A and Model B discovery models are defined in 3GPP TS 23.304. Model A and Model B may be supported for WTRU-to-Network (U2N) relay discovery.

In certain representative embodiments, a WTRU 102 may perform U2N relay discovery using Model A. For example, Relay WTRUs 102 may broadcast Relay Discovery Messages to advertise their presence and any connectivity service they can or may provide. Remote WTRUs, or other relay WTRUs (e.g., in cases where multi-hop is supported) may actively listen for and/or obtain the broadcast messages.

In certain representative embodiments, a WTRU 102 may perform U2N relay discovery using Model B. For example, the relay discovery procedure may be initiated by a remote WTRU 102 which broadcasts solicitation messages (e.g., with the connectivity service the remote WTRU is looking for). Listening relay WTRUs that provide the solicited service may then send a response message (e.g., to the remote WTRU).

For example, a U2N remote WTRU 102 may perform relay discovery solicitation message transmission and/or may monitor SL resources for relay discovery messages, such as while in any of RRC_IDLE, RRC_INACTIVE and/or RRC_CONNECTED. The network may broadcast a threshold, which is used by any U2N remote WTRUs to determine if the U2N remote WTRUs can transmit relay discovery solicitation messages to any U2N relay WTRUs.

For example, a U2N relay WTRU 102 may perform relay discovery message transmission and/or may monitor SL resources for relay discovery messages, such as while in any of RRC_IDLE, RRC_INACTIVE and/or RRC_CONNECTED. The network may broadcast a maximum Uu RSRP threshold, a minimum Uu RSRP threshold, or both, which may be used by the U2N Relay WTRU to determine if it can transmit relay discovery messages to any U2N remote WTRUs.

For example, the network may provide a relay discovery configuration using broadcast and/or dedicated signaling for relay discovery. As another example, the U2N remote WTRUs and U2N relay WTRUs may use a pre-configuration for relay discovery.

In certain representative embodiments, a WTRU 102 may determine from system information (e.g., a system information block, such as SIB12) whether a gNB 180 supports relay discovery and/or non-relay discovery.

### Relay Selection and Relay Reselection

In certain representative embodiments, SL relay selection and/or reselection may be performed by a remote WTRU 102. For example, SL relay selection and/or reselection may be performed while the remote WTRU is in any of RRC_IDLE, RRC_INACTIVE, and/or RRC_CONNECTED.

In certain representative embodiments, a (e.g., U2N remote) WTRU 102 performs radio measurements at a PC5 interface. The WTRU 102 may use the PC5 interface measurements for U2N relay selection and/or reselection, such as in combination with higher layer criteria, such as specified in 3GPP TS 23.304. On condition that there is no (e.g., unicast) PC5 connection between a U2N relay WTRU and a U2N remote WTRU, the U2N remote WTRU may uses SL discovery reference signal received power (SD-RSRP) measurements to evaluate whether PC5 link quality towards a U2N relay WTRU satisfies relay selection criterion.

For relay reselection, a U2N remote WTRU may use SL-RSRP measurements towards a serving U2N relay WTRU for relay reselection trigger evaluation, such as when there is data transmission from the U2N relay WTRU to the U2N remote WTRU. As examples, the U2N relay WTRU may use any of SL-RSRP and/or SD-RSRP for relay reselection trigger evaluation, such when there is no data transmission from the U2N relay WTRU to the U2N remote WTRU.

In certain representative embodiments, a U2N relay WTRU may be considered suitable by a U2N remote WTRU in terms of radio criteria on condition that a PC5 link quality measured by the U2N remote WTRU towards the U2N relay WTRU exceeds a threshold (e.g., pre-configured, configured, or otherwise provided by a gNB 180). The U2N remote WTRU may search for suitable U2N relay WTRU candidates that meet any (e.g., all) AS layer and/or higher layer criteria, such as specified in TS 23.304. On condition that there are multiple such suitable U2N relay WTRUs, the U2N Remote WTRU may choose one U2N Relay WTRU among them. For example, in L2 U2N relay (re) selection, the PLMN ID and/or the cell ID may be used as (e.g., additional) AS criteria.

In certain representative embodiments, a U2N remote WTRU may trigger U2N relay selection in any of the following cases:
Direct Uu signal strength of current serving cell of the U2N Remote UE is below a configured signal strength threshold; and/or
Indicated by upper layer of the U2N Remote UE.

In certain representative embodiments, a U2N remote WTRU may trigger U2N relay reselection in any of the following cases:
PC5 signal strength of current U2N Relay WTRU is below a (pre) configured signal strength threshold;
Cell (re) selection, handover or Uu radio link failure (RLF) has been indicated by the U2N Relay WTRU via PC5-RRC signaling;
When the remote WTRU receives a PC5-S link release message from a U2N Relay WTRU;
When the U2N remote WTRU detects a PC5 RLF; and/or
Indicated by upper layers.

In certain representative embodiments, any L2 U2N remote WTRUs (e.g., in RRC_IDLE and/or RRC_INACTIVE) and L3 U2N remote WTRUs, the cell (re) selection procedure and relay (re) selection procedures may be performed independently. If both suitable cells and suitable U2N Relay WTRUs are available, a remote WTRU may select either a cell or a U2N Relay WTRU. As an example, a (e.g., L3) U2N remote WTRU may select a cell and a U2N relay WTRU simultaneously.

In certain representative embodiments, for any L2 and/or L3 U2N relay WTRUs (e.g., in RRC_IDLE and/or RRC_INACTIVE), PC5-RRC message(s) may be used to inform their connected remote WTRUs when the U2N relay WTRU selects a new cell. PC5-RRC message(s) may (e.g., also) be used to inform their connected L2 and/or L3 U2N remote WTRUs when L2 and/or L3 U2N relay WTURs perform a handover and/or detects Uu RLF. Upon reception of the PC5 RRC message for notification, a U2N remote WTRU may determine to release or keep the unicast PC5 link. For example, a U2N remote WTRU may determine to release the unicast PC5 link, trigger the L2 release procedure, and perform relay reselection.

In 3GPP Release 17, SL U2N relaying focuses on out-of-coverage (OOC) remote WTRUs. As discussed above, work on SL relays for 3GPP Release 18 is expected to cover cases where a remote WTRU is operating in multipath scenarios when in coverage of the network (e.g., one path over direct Uu, and another path via a SL U2N relay). This may allow for more flexible use of both relayed and non-relayed paths by a remote WTRU.

As described above, in NR, for remote WTRUs in RRC_IDLE and/or RRC_INACTIVE, the Uu cell reselection and the relay (re) selection procedures may be performed independently. That is, on condition that both a suitable Uu cell and a suitable U2N relay WTRU are available, the remote WTRU may determine whether to select the Uu cell or the U2N relay WTRU.

With the introduction of multipath operation with SL, the independent selection and/or reselection of a Uu interface and a SL interface may lead to sub-optimal operation when a remote WTRU transits to CONNECTED mode. For example, a WTRU may have two candidate Uu cells (e.g., cells 1 and 2) it may select. Additionally, there may be a relay WTRU that is currently associated with the second cell (e.g., the relay WTRU is either in RRC_CONNECTED, or in RRC_IDLE and/or RRC_INACTIVE but camping on the second cell). The WTRU may decide to camp on cell 1, such as where cell 1 has (e.g., only marginally) better radio conditions than cell 2. When the WTRU may transition to RRC_CONNECTED (e.g., arrival of UL data, paged due to DL data, etc.), the WTRU may send a RRC Setup request (e.g., if it was in RRC_IDLE) or a RRC Resume request (e.g., if it was in RRC_INACTIVE). The WTRU may be first configured (e.g., only) with the Uu link. Further measurement reporting and HO signaling may be required if the WTRU is to be configured for multipath operation with cell 2 and the SL towards the relay UE.

### Overview

In certain representative embodiments, a WTRU 102 (e.g., a remote WTRU in RRC_IDLE and/or RRC_INACTIVE) may perform cell selection and/or reselection in consideration of available multipath opportunities.

In certain representative embodiments, a WTRU 102 may be configured with information and/or determine multipath availability of cells, such as serving and/or neighboring cells of a RAN 104/113.

In certain representative embodiments, a WTRU 102 may be configured with information and/or determine to prioritize cells that provide multipath operations and/or connections for cell selection and/or reselection procedures.

In certain representative embodiments, a (e.g., remote) WTRU 102, in one or more connection states (e.g., IDLE and/or INACTIVE), may be configured with information and/or determine to prioritize and/or (e.g., only) consider cells that may provide multipath operation, such as when performing cell selection and or cell reselection.

In certain representative embodiments, a (e.g., remote) WTRU 102, in one or more connection states (e.g., IDLE and/or INACTIVE), may be configured with information and/or determine to apply offsets related to sidelink (SL) radio link quality and/or SL channel busy ratio (CBR) when performing the SL criterion evaluation during cell selection and/or reselection.

In certain representative embodiments, a (e.g., remote) WTRU 102, in one or more connection states (e.g., IDLE and/or INACTIVE), may be configured with information and/or determine to apply offsets related to SL radio link quality and/or SL CBR when performing the cell ranking evaluation during cell reselection.

In certain representative embodiments, a WTRU 102, in one or more connection states (e.g., IDLE and/or INACTIVE), may be configured with information and/or determine to establish a PC5 connection with a (e.g., candidate) relay WTRU that may provide multipath operation with a (e.g., current) cell that the WTRU 102 is camping on.

In certain representative embodiments, a WTRU 102, in one or more connection states (e.g., IDLE and/or INACTIVE), may be configured with information and/or determine to prioritize a cell where the WTRU 102 already has a sideline (SL) connection established that is served by the same cell or a cell of a same base station (e.g., gNB 180) as the concerned cell.

In certain representative embodiments, a WTRU 102 may be configured with information and/or determine to apply an offset for a cell during cell selection criterion evaluation. For example, the cell selection may depend on multipath operation availability and/or a quality of a SL signal level with a candidate relay WTRU to be used for multipath operation.

In certain representative embodiments, a WTRU 102 may be configured with information and/or determine to apply an offset for a cell during cell selection criterion evaluation. For example, the cell selection may depend on multipath operation availability, the CBR and/or channel occupation ratio (CR) on a SL towards a candidate relay WTRU to be used for multipath operation.

In certain representative embodiments, a WTRU 102 may be configured with information and/or determine to apply an offset for a serving cell and/or a neighbor cell during cell ranking evaluation for cell reselection. For example, the cell ranking and/or reselection that may depend on multipath operation availability and/or a quality of a SL signal level with a candidate relay WTRU to be used for multipath operation, such as with the serving cell and/or the neighbor cell.

In certain representative embodiments, a WTRU 102 may be configured with information and/or determine to apply an offset for a serving cell or/and a neighbor cell during cell ranking evaluation for cell reselection. For example, the cell ranking and/or reselection may depend on multipath operation availability, the CBR and/or CR on a SL towards a candidate relay WTRU to be used for multipath operation, such as with the serving cell and/or the neighbor cell.

As described herein, the terms PC5 and SL may be used interchangeably.

As described herein, embodiments may be described with respect to L2 U2N relay scenarios but may be equally applicable to L3 as well.

As described herein, the term WTRU 102 may refer to a remote WTRU (e.g., in RRC_IDLE and/or RRC_INACTIVE) unless otherwise specified.

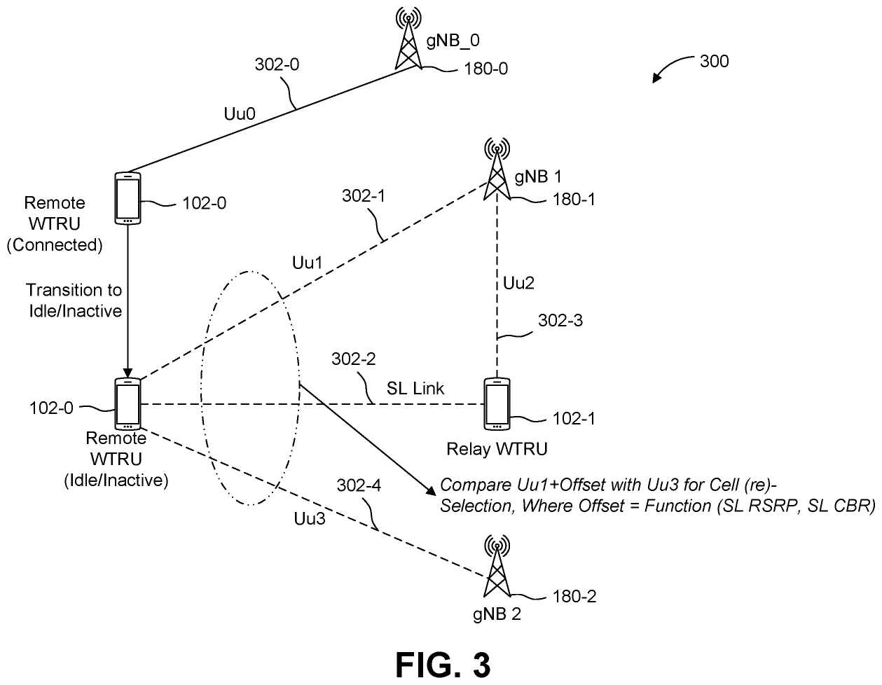

FIG. 3 is a system diagram illustrating an example of cell selection in an example communications system 300. As shown in FIG. 3, a (e.g., remote) WTRU 102-0 may communicate with a first gNB (e.g., gNB_0) 180-0 using a first Uu interface (e.g., Uu0) 302-0 in a connected state (e.g., RRC_CONNECTED). In certain representative embodiments, the WTRU 102-0 may transition to the idle or inactive state (e.g., RRC_IDLE or RRC_INACTIVE). After transitioning to the idle or inactive state (e.g., RRC_IDLE or RRC_INACTIVE), the remote WTRU 102-0 may perform measurements on multiple interfaces. For example, the remote WTRU 102-0 may perform measurements on a second Uu interface (e.g., Uu1) 302-1 associated with a second gNB (e.g., gNB_1) 180-1. For example, the remote WTRU 102-0 may perform measurements on a SL link (e.g., PC5 interface) 302-2 associated with a relay WTRU 102-1. The relay WTRU 102-1 may provide multipath connectivity to the gNB 180-1, such as via a third Uu interface (e.g., Uu2) 302-3. For example, the remote WTRU 102-0 may perform measurements on a fourth Uu interface (e.g., Uu3) 302-4 associated with a third gNB (e.g., gNB_2) 180-2. The remote WTRU 102-0 may perform a comparison using the measurements. As an example, the remote WTRU 102-0 may compare the measurements of the second Uu interface (e.g., Uu1) which is modified by an offset with the measurements of the fourth Uu interface (e.g., Uu3). For example, the offset may be determined based on a function of the measurements on the SL link, such as SL RSRP and SL CBR.

### Configuration

### Awareness of Multipath Opportunities

In certain representative embodiments, a WTRU 102 may be configured to assume, or determine, multipath operation is available on a (e.g., any) Uu cell being measured. For example, the WTRU 102 may determine multipath operation is available where the WTRU 102 detects a SL relay that the WTRU 102 may connect to, and the SL relay is being served by the same cell.

In certain representative embodiments, a WTRU 102 may be configured to assume, or determine, multipath operation is available on a (e.g., any) Uu cell being measured. For example, the WTRU 102 may determine multipath operation is available where the WTRU 102 detects a SL relay that the WTRU 102 can connect to, and the SL relay is being served by a cell that belongs to a same gNB 180 as the Uu cell being measured.

In certain representative embodiments, a WTRU 102 may be configured with information regarding any neighbor and/or serving cell having availability for multipath operation. For example, the WTRU 102 may obtain and/or determine availability of multipath operation while in RRC_CONNECTED (e.g., via RRC reconfiguration). For example, the WTRU 102 may be configured with the availability information via Uu signaling and/or PC5 signaling (e.g., RRC signaling).

In certain representative embodiments, a WTRU 102 may be configured with information regarding any neighbor and/or serving cell having availability for multipath operation during a transition from RRC_CONNECTED to RRC_IDLE and/or RRC_INACTIVE (e.g., in a RRC release message).

In certain representative embodiments, a WTRU 102 may be provided (e.g., configured) with information regarding a cell's multipath operation capability via broadcast signaling. For example, the broadcast signaling may be received using the Uu interface (e.g., via SIB).

In certain representative embodiments, a WTRU 102 may be configured with information regarding a cell's multipath operation capability via signaling over the PC5 interface. For example, the signaling may be received as any of PC5 RRC signaling and/or Uu SIB signaling (e.g., forwarded via PC5).

In certain representative embodiments, a WTRU 102 (e.g., in RRC_CONNECTED) may request the network about multipath availability information about a serving cell. For example, the WTRU 102 may send the request via any of Uu signaling (e.g., via an RRC message, MAC CE, etc.) and/or PC5 signaling (e.g., PC5 RRC).

In certain representative embodiments, a WTRU 102 (e.g., in RRC_CONNECTED) may request the network about multipath availability information about a non-serving cell (e.g., via an RRC message, MAC CE, etc.). For example, the WTRU 102 may send the request via any of Uu signaling (e.g., via an RRC message, MAC CE, etc.) and/or PC5 signaling (e.g., PC5 RRC).

In certain representative embodiments, a WTRU 102 may be configured with multipath operation information by explicit and/or implicit indication to the WTRU 102 to consider multipath aspects during cell selection and/or reselection.

In certain representative embodiments, a WTRU 102 (e.g., in RRC_CONNECTED) may be configured, or determine, to consider multipath aspects during cell selection and/or cell reselection (e.g., via RRC reconfiguration). For example, the WTRU 102 may determine multipath operation is available via any of Uu RRC signaling and/or PC5 RRC signaling. As an example, a WTRU 102 may not receive an explicit information (e.g., configuration/reconfiguration) as to whether any cells provide multipath operation, and may determine (e.g., by discovery) of any relay WTRUs camping on a cell and/or gNB 180. On condition that the WTRU 102 determines a relay WTRU is camping, the WTRU may receive a (e.g., explicit and/or separate) configuration, or determine to, consider multipath operation during cell selection and/or re-selection.

In certain representative embodiments, a WTRU 102 may be configured and/or determine, such as during a transition from RRC_CONNECTED to RRC_IDLE and/or RRC_INACTIVE (e.g., in RRC release message), to consider multipath aspects during cell selection and/or cell reselection. As an example, a WTRU 102 may not receive an explicit information (e.g., configuration/reconfiguration) as to whether any cells provide multipath operation, and may determine (e.g., by discovery) of any relay WTRUs camping on a cell and/or gNB 180. On condition that the WTRU 102 determines a relay WTRU is camping, the WTRU may receive a (e.g., explicit and/or separate) configuration, or determine to, consider multipath operation during cell selection and/or re-selection.

In certain representative embodiments, a WTRU 102 may be configured and/or determine to consider multipath aspects during cell selection and/or cell reselection via broadcast signaling (e.g., Uu SIB, Uu SIB signaling forwarded via PC5, etc.). As an example, a WTRU 102 may not receive an explicit information (e.g., configuration/reconfiguration) as to whether any cells provide multipath operation, and may determine (e.g., by discovery) of any relay WTRUs camping on a cell and/or gNB 180. On condition that the WTRU 102 determines a relay WTRU is camping, the WTRU may receive broadcast signaling which may include information indicating to consider multipath operation during cell selection and/or re-selection.

### Multipath Availability Information

In certain representative embodiments, a WTRU 102 may receive multipath availability information which includes information indicating and/or associating any of: a list of cells, a list of frequencies, and/or SL relay WTRU identifiers (e.g., L2 identities).

In certain representative embodiments, a WTRU 102 may receive multipath availability information which includes information (e.g., a flag and/or indication) as to whether a cell or plural cells (e.g., a cell list) provides and/or supports multipath operation. For example, the WTRU 102 may receive a broadcast information from a cell and/or dedicated message in response to a request from the WTRU 102. For example, the WTRU 102 may receive a dedicated message, such as in response to a request from the WTRU 102 about any (e.g., specific) serving and/or non-serving cell(s).

### WTRU Behavior During Cell Selection and Reselection

Prioritization of Cells that Support Multipath for Cell Selection and/or Reselection

In certain representative embodiments, a WTRU 102 may perform cell selection (e.g., in transitioning from RRC_CONNECTED to RRC_IDLE and/or RRC_INACTIVE, etc.). The WTRU 102 may be configured to select (e.g., only) cells that can provide multipath operation. For example, the WTRU 102 may select a cell that provides multipath operation, such as on condition that a suitable cell can be found among any cells that provide multipath operations. For example, on condition that no suitable cell is found among the cells that can provide multipath operations, the WTRU 102 may be configured to (e.g., then) consider cells that do not provide multipath operation.

In certain representative embodiments, a WTRU 102 may perform cell selection (e.g., in transitioning from RRC_CONNECTED to RRC_IDLE and/or RRC_INACTIVE, etc.), and may be configured to select (e.g., only) cells that can provide multipath operations. For example, the WTRU 102 may select a cell that provides multipath operation on condition that a suitable cell can be found among the cells that can provide multipath operations, and there is a relay WTRU available for multipath operation with that cell and/or with a cell that belongs to the same gNB as that cell. For example, the WTRU 102 may receive a relay discovery message received indicating the presence and/or availability of the relay WTRU. On condition that no such cell is found, the WTRU 102 may be configured to (e.g., then) consider cells that do not provide multipath operation for cell selection.

In certain representative embodiments, a WTRU 102 may perform cell selection (e.g., in transitioning from RRC_CONNECTED to RRC_IDLE and/or RRC_INACTIVE, etc.,) and may be configured to initiate and/or transmit a relay discovery solicitation message. The WTRU 102 may determine whether a relay WTRU is available for multipath operations with a candidate cell being measured for cell selection and/or with a cell that belongs to a same gNB as that cell via relay discovery.

In certain representative embodiments, a WTRU 102 may perform cell selection (e.g., in transitioning from RRC_CONNECTED to RRC_IDLE and/or RRC_INACTIVE, etc.,) and may be configured to and/or determine to select a suitable cell that provides multipath operation, and to trigger the setup of a PC5 link with a relay UE that can provide the multipath operation.

In certain representative embodiments, a WTRU 102 may perform cell selection (e.g., in transitioning from RRC_CONNECTED to RRC_IDLE and/or RRC_INACTIVE, etc.,) and may be configured to and/or determine to, before selecting a suitable cell that provides multipath operations, to trigger the setup of a PC5 link with a relay WTRU. For example, the WTRU 102 may setup the PC5 link with a relay WTRU that can provide multipath operation, and may (e.g., only) perform the cell selection towards the concerned cell, such as (e.g., only) after the PC5 link setup is successful.

In certain representative embodiments, a WTRU 102 may perform cell selection (e.g., in transitioning from RRC_CONNECTED to RRC_IDLE and/or RRC_INACTIVE, etc.,) and may trigger the setup of a PC5 link with a relay WTRU. For example, the relay WTRU may (e.g., be determined to) provide multipath operation with a given cell as described herein. The WTRU 102 may be configured to trigger the setup of a PC5 link with any relay WTRU that can provide multipath operation, such as where there are several such relay WTRUs available.

In certain representative embodiments, a WTRU 102 may perform cell selection (e.g., in transitioning from RRC_CONNECTED to RRC_IDLE and/or RRC_INACTIVE, etc.,) and may trigger the setup of a PC5 link with a relay WTRU. For example, the relay WTRU may (e.g., be determined to) provide multipath operation with a given cell as described herein. The WTRU 102 may be configured to setup a PC5 link with a relay WTRU that can provide multipath operation with a given cell as described herein, and may trigger the setup of the PC5 link with the relay WTRU that has a best or preferred radio quality among any candidate relay WTRUs available.

In certain representative embodiments, a WTRU 102 may perform cell selection (e.g., in transitioning from RRC_CONNECTED to RRC_IDLE and/or RRC_INACTIVE, etc.,) and may trigger the setup of a PC5 link with a relay WTRU. For example, the relay WTRU may (e.g., be determined to) provide multipath operation with a given cell as described herein. The WTRU 102 may be configured to setup a PC5 link with a relay WTRU that can provide multipath operation with a given cell as described herein, and may trigger the setup of the PC5 link with the relay WTRU that has a best or preferred radio quality among any candidate relay WTRUs available and the relay WTRU has a radio quality above a (e.g., configured) radio quality threshold.

In certain representative embodiments, a WTRU 102 may perform CBR and/or CR measurements, such as while in RRC_IDLE and/or RRC_INACTIVE. For example, the WTRU 102 may be configured to keep (e.g., store) any CBR and/or CR measurement configuration that was provided while in RRC_CONNECTED mode. For example, the WTRU 102 may be provided with any CBR and/or CR measurement configuration in transitioning from RRC_CONNECTED to RRC_IDLE and/or RRC_INACTIVE, such as in a RRC Release message. For example, the WTRU may report CBR and/or CR measurements performed in CONNECTED mode, and/or may not report CBR and/or CR measurements performed in IDLE and/or INACTIVE.

In certain representative embodiments, a WTRU 102 may perform cell selection (e.g., in transitioning from RRC_CONNECTED to RRC_IDLE and/or RRC_INACTIVE, etc.,) and may initiate the setup of a PC5 link with a relay WTRU that can provide multipath operation with a given cell as described herein. For example, the WTRU 102 may be configured to check (e.g., determine) that the CBR and/or CR on the SL towards the concerned relay WTRU is below a certain configured threshold.

As described above, and elsewhere herein, certain representative embodiments may be combined and/or modified. For example, a WTRU 102 may be configured to consider both a radio quality satisfying a threshold as well as CBR and/or CR measurements satisfying thresholds with respect to a candidate relay WTRU. As another example, a WTRU 102 may be configured to consider if any of a radio quality, CBR, and/or CR measurements satisfy a (e.g., respective) threshold with respect to a candidate relay WTRU.

In certain representative embodiments, a WTRU 102 may determine a radio quality and/or a CBR and/or a CR towards a candidate relay WTRU. For example, the WTRU 102 may determine any of the radio quality, CBR, and/or CR before (or without) establishing a PC5 link. For example, the WTRU 102 may (e.g., only) check the availability of a relay WTRU after determining or selecting a cell that can provide multipath operation.

In certain representative embodiments, a WTRU 102 may be configured (e.g., substantially) the same way for cell reselection as embodiments discussed herein for cell selection. For example, a WTRU 102 may (e.g., only) consider a neighbor cell for cell reselection where the neighbor cell can provide multipath operation. For example, a WTRU 102 may (e.g., only) consider a neighbor cell for cell reselection where there is an available relay WTRU for multipath operations on that cell. For example, a WTRU 102 may (e.g., only) consider a neighbor cell for cell reselection where there is an available relay WTRU with a signal level, CBR, and/or CR above a (e.g., specific configured) threshold.

In certain representative embodiments, a WTRU 102 may be configured to determine whether a cell is candidate for cell selection or reselection with a same or similar behavior. For example, the WTRU may determine whether a cell is candidate for cell selection or reselection in a same way using different (e.g., configured) threshold values, such as SL radio quality, CBR, CR, etc., for cell selection considerations as compared with cell reselection considerations.

In certain representative embodiments, a WTRU 102 may be configured to determine whether a cell is candidate for cell selection or reselection with different behavior. For example, the WTRU 102 may behave differently (e.g., different criteria and/or thresholds) for cell reselection as compared to cell selection, such as for prioritization of cells based on multipath operation availability. For example, the WTRU 102 may be configured as described herein for cell selection and may be provided with a first configuration for cell reselection (e.g., WTRU configured to consider SL radio quality and CBR thresholds for cell selection) that is different from a second configuration applied for cell reselection (e.g., WTRU configured to consider only SL radio quality for cell reselection).

### Modified Criterion S

Cell Selection with CBR and/or CR

In certain representative embodiments, a WTRU 102 may be configured to apply one or more offsets on Uu measurements, such as when evaluating the criterion S for cell selection. For example, an offset value may be a function of the CBR and/or CR of a SL of a relay WTRU (e.g., a candidate relay WTRU where the WTRU has no PC5 connection or a relay WTRU with which the WTRU already has a PC5 connection). For example, the WTRU 102 may be configured to apply an offset1 where the CBR and/or CR is below a threshold1 (e.g., add offset1 to the concerned cell's Uu Rx or quality measurement to determine the Srxlev and/or Squal values), apply offset2 where the CBR and/or CR is between threshold1 and threshold2, apply offset3 where the CBR and/or CR is between threshold2 and threshold3, and/or apply no offset where the CBR and/or CR is above threshold3. In other examples, one, two, four or more offsets may apply.

In certain representative embodiments, a WTRU 102 may be configured with a baseline offset (e.g., baseline_offset) to add to serving Uu measurements for a certain baseline CBR threshold (e.g., cbr1) and/or a scaling factor/function that may depend on the current CBR as compared to the baseline CBR threshold. For example, the WTRU 102 may apply no offset for a CBR above cbr1, and/or for CBRs below or equal to cbr1, the WTRU 102 may calculate the offset to be baseline_offset*(cbr1/Current_CBR)*scaling_factor. For example, a limit may (e.g., also) be specified so as to prevent the offset from increasing without limit or to an undesirably high value. For example, a maximum offset may be configured to be a maximum x % of the baseline_offset, where x>1. As an example, the offset may be calculated as baseline_offset*min (x, (cbr1/Current_CBR)*configured_scaling_factor). A maximum offset may (e.g., also) be specified as absolute value (max_offset). For example, an offset to be applied may be calculated as min (max_offset, baseline_offset*(cbr1/Current_CBR)*configured_scaling_factor).

Cell Selection with SL Radio Quality

In certain representative embodiments, a WTRU 102 may be configured to apply one or more offsets on Uu measurements when evaluating the criterion S for cell selection. For example, the offset value may be a function of the SL radio quality of the relay WTRU of the multipath (e.g., a candidate relay WTRU where the WTRU has no PC5 connection or a relay WTRU with which the WTRU already has a PC5 connection). For example, the WTRU 102 may be configured to apply no offset where the SL radio quality is below a threshold1, apply an offset1 where the SL radio quality is between the threshold1 and a threshold2 (e.g. add offset1 to the concerned cell's Uu Rx or quality measurement to determine the Srxlev and/or Squal values), apply an offset2 where the SL radio quality is between the threshold2 and a threshold3, and/or apply an offset3 where the SL radio quality is above the threshold3. In other examples, one, two, four or more offsets may apply.

In certain representative embodiments, a WTRU 102 may be configured with a baseline offset (e.g., baseline_offset) to add to the serving Uu measurements for a certain baseline SL radio quality (e.g., sl_quality1) and/or a scaling factor/function that may depend on a current SL radio quality as compared to the baseline radio quality. For example, the WTRU 102 may determine the offset to be baseline_offset*(current_SL_quality/sl_quality1)*scaling_factor. For example, a limit may (e.g., also) be specified so as to prevent the offset from increasing without limit or to an undesirably high value. For example, a maximum offset may be configured to be a maximum x % of the baseline_offset. As an example, the offset may be calculated as baseline_offset*min (x, (current_SL_quality/sl_quality1)*configured_scaling_factor). For example, a maximum offset may (e.g., also) be specified as an absolute value instead of as a comparison to the baseline (max_offset). For example, an offset to be applied may be calculated as min (max_offset, baseline_offset*(current_SL_quality/sl_quality1)*configured_scaling_factor).

### Modified Criterion R

Cell Ranking for Cell Reselection with CBR and/or CR

In certain representative embodiments, a WTRU 102 may be configured with one or more offsets to apply on top of (e.g., add to) of measurements (e.g., Uu measurements) of a serving cell, such as for evaluating criterion R for cell reselection. For example, an offset value may be a function of CBR and/or CR of the SL of a relay WTRU (e.g., a candidate relay WTRU where the WTRU has no PC5 connection or a relay WTRU with which the WTRU already has a PC5 connection). For example, the WTRU 102 may be configured to apply an offset1 where CBR and/or CR is below a threshold1 (e.g., add offset1 to the concerned cell's Qmeas to determine the Rs value), apply an offset2 where CBR and/or CR is between the threshold1 and a threshold2, apply an offset3 where CBR and/or CR is between the threshold2 and a threshold3, and/or apply no offset where CBR and/or CR is above the threshold3. In other examples, one, two, four or more offsets may be applied.

In certain representative embodiments, a WTRU 102 may be configured with a baseline offset (e.g., baseline_offset) to add to serving Uu measurements for a certain baseline CBR threshold (e.g., cbr1) and/or a scaling factor/function that may depend on a current CBR as compared to the baseline CBR threshold. For example, the WTRU 102 may apply no offset for a CBR above cbr1 and for CBRs below or equal to cbr1, the WTRU 102 may calculate an offset to be baseline_offset*(cbr1/Current_CBR)*scaling_factor. For example, a limit may (e.g., also) be specified so as to prevent the offset from increasing without limit or to an undesirably high value. For example, a maximum offset may be configured to be a maximum x % of the baseline_offset, where x>1. As an example, the offset may be calculated as baseline_offset*min (x, (cbr1/Current_CBR)*configured_scaling_factor). A maximum offset may (e.g., also) be specified as absolute value (max_offset). For example, an offset to be applied may be calculated as min (max_offset, baseline_offset*(cbr1/Current_CBR)*configured_scaling_factor).

In certain representative embodiments, a WTRU 102 may be configured with (e.g., similar) offset considerations that may be applied to a neighbor cell (e.g., for determining Rn), such as where the WTRU 102 has determined that the neighbor cell is also capable of multipath operations (e.g., WTRU explicitly configured that the neighbor cell supports multipath, WTRU has determined that there is a relay WTRU available that can provide multipath operation on that neighbor cell, WTRU has a PC5 connection with a relay WTRU that is camping on the neighbor cell, etc.).

In certain representative embodiments, a WTRU 102 may be configured with (e.g., same) offset values which may be applied on top of (e.g., added to) serving cell and/or neighbor cell measurements.

In certain representative embodiments, a WTRU 102 may be configured with (e.g., different) offset values which may be applied on top of (e.g., added to) serving cell and neighbor cell measurements separately. For example, a first set of offsets may be configured for a serving cell and a second set of offsets may be configured for a neighbor cell.

Cell Ranking for Cell Reselection with SL Radio Quality

In certain representative embodiments, a WTRU 102 may be configured with one or more offsets to apply on top of (e.g., add to) the WTRU's measurement of a serving cell, such as when evaluating criterion R for cell reselection. For example, an offset value may be a function of the SL radio quality of a relay WTRU (e.g., a candidate relay WTRU where the WTRU has no PC5 connection or a relay WTRU with which the WTRU already has a PC5 connection). For example, the WTRU 102 may be configured to apply no offset where the SL radio quality is below a threshold1, apply an offset1 where the SL radio quality is between the threshold1 and a threshold2 (e.g., add offset1 to the concerned cell's Qmeas to determine the Rs value), apply an offset2 where the SL radio quality is between the threshold1 and threshold2, and/or apply an offset3 where the SL radio quality is above a threshold3. In other examples, one, two, four or more offsets may apply.

In certain representative embodiments, a WTRU 102 may be configured with a baseline offset (e.g., baseline_offset) to add to the serving Uu measurements for a certain baseline SL radio quality (e.g., baseline_offset) and/or a scaling factor/function may depend on the current SL radio quality as compared to the baseline radio quality. For example, the WTRU 102 may determine an offset to be baseline_offset*(current_SL_quality/sl_quality1)*scaling_factor. For example, a limit may (e.g., also) be specified so as to prevent the offset from increasing without limit or to an undesirably high value. For example, a maximum offset may be configured to be a maximum x % of the baseline_offset. For example, an offset may be calculated as baseline_offset*min (x, (current_SL_quality/sl_quality1)*configured_scaling_factor). A maximum offset may (e.g., also) be specified as an absolute value instead of as a comparison to the baseline (max_offset). For example, the offset to be applied is now calculated as min (max_offset, baseline_offset*(current_SL_quality/sl_quality1)*configured_scaling_factor).

In certain representative embodiments, a WTRU 102 may be configured with (e.g., similar) offset considerations that may be applied to a neighbor cell (e.g., for determining Rn), such as where the WTRU 102 has determined that the neighbor cell is also capable of multipath operations (e.g., WTRU explicitly configured that the neighbor cell supports multipath, WTRU has determined that there is a relay WTRU available that can provide multipath operation on that neighbor cell, WTRU has a PC5 connection with a relay WTRU that is camping on the neighbor cell, etc.).

In certain representative embodiments, a WTRU 102 may be configured with (e.g., same) offset values which may be applied on top of (e.g., added to) serving cell and/or neighbor cell measurements.

In certain representative embodiments, a WTRU 102 may be configured with (e.g., different) offset values which may be applied on top of (e.g., added to) serving cell and neighbor cell measurements separately. For example, a first set of offsets may be configured for a serving cell and a second set of offsets may be configured for a neighbor cell.

### Combined S and R Criteria for Cell Reselection

In certain representative embodiments, a WTRU 102 may consider (e.g., only) those cells that fulfill or satisfy the criterion S for cell ranking.

In certain representative embodiments, a WTRU 102 may, for cell reselection purposes, apply any offsets as described herein when evaluating the criterion S (e.g., as in the case of cell selection), and perform legacy procedures for cell ranking.

In certain representative embodiments, a WTRU 102 may, for cell reselection purposes, evaluate the criterion S using legacy procedures (e.g., without any offsets according to the description herein), and may perform cell ranking procedures using (e.g., applying) any offsets described herein.

In certain representative embodiments, a WTRU 102 may, for cell reselection purposes, apply any offsets as described herein when evaluating the criterion S (e.g., as in the case of cell selection), and may perform cell ranking procedures using (e.g., applying) any offsets described herein.

In certain representative embodiments, a WTRU 102 may use offset values, as described herein, for criterion S evaluations, and may use the same offset values for the criterion R evaluation.

In certain representative embodiments, a WTRU 102 may use offset values, as described herein, for criterion S evaluations, and may use a portion (e.g., less than all) of the same offset values for the criterion R evaluation.

### Other Modified Embodiments

Any of the representative embodiments described herein, in which a WTRU 102 determines one or more offsets to apply on top of serving Uu measurements for criterion S and/or criterion R, may be combined and/or modified. As an example, a WTRU 102 may consider both SL CBR and/or CR and SL radio quality (e.g., a certain offset value may be associated with a CBR value/range and a SL radio quality value/range).

As another example, a certain SL radio quality threshold may be configured for a WTRU 102. On condition that a (e.g., measured) SL radio quality is determined to be below this level, the WTRU 102 may not consider SL features as described herein. On condition that the SL radio quality is above this level, the WTRU 102 may apply a configured offset determination procedure based on a current CBR and/or CR range and/or value, such as by using a (e.g., configured) mapping between the CBR/CR value/range and an offset as described herein.

As another example, a certain CBR and/or CR threshold specified may be configured for a WTRU 102. On condition that a (e.g., measured) SL CBR is above this level, the WTRU 102 may not consider SL CBR features as described herein. On condition that the SL CBR is below this level, the WTRU 102 may apply a configured offset determination procedure based on the current SL radio quality value and/or range, such as by using a (e.g., configured) mapping between the SL radio quality value/range and an offset as discussed above.

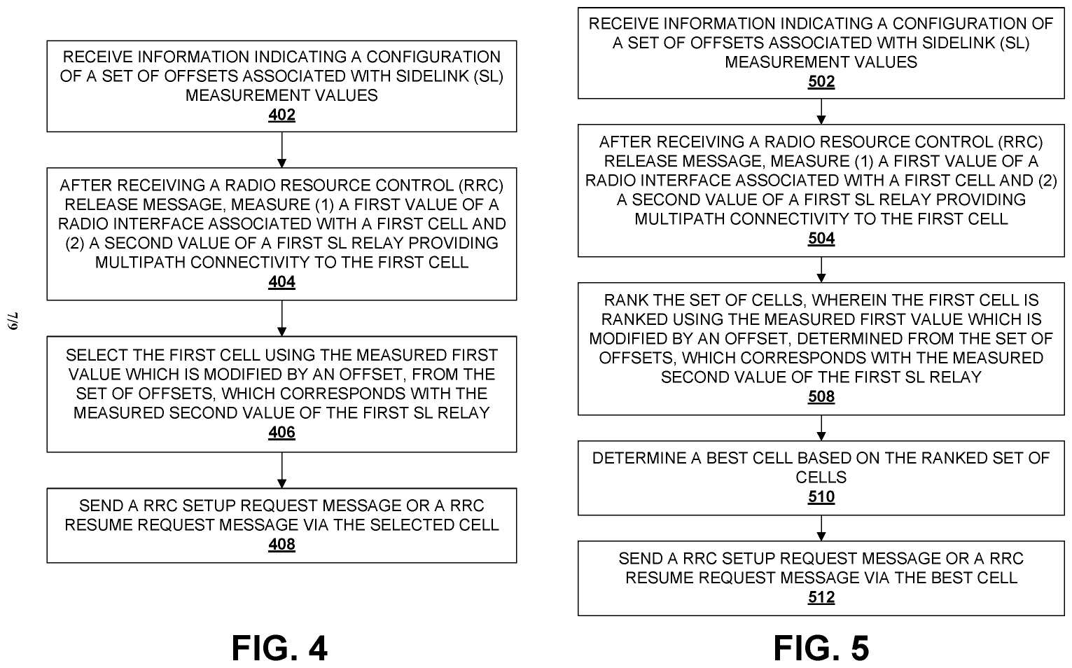

FIG. 4 is a procedural diagram illustrating an example procedure for cell selection. For example, the procedure in FIG. 4 may be implemented by a WTRU 102 (e.g., a remote WTRU) for cell selection. As shown at 402, a WTRU 102 may receive information indicating a configuration of a set of offsets that are associated with SL measurement values. At 404, the (e.g., remote) WTRU 102, after receiving a RRC release message (e.g., after the WTRU 102 is in RRC_Inactive or RRC_Idle), may measure (1) a first value of a radio interface associated with a first cell and (2) a second value of a first SL relay providing multipath connectivity to the first cell. For example, the first value may be a measurement of a radio interface which is a direct (e.g., Uu) link to the first cell. For example, the second value may be a measurement of a SL interface (e.g., associated with a relay WTRU) which is an indirect (e.g., PC5) link to the first cell. At 406, the WTRU 102 may select (or reselect) the first cell using the measured first value which is modified by an offset, (e.g., determined) from the set of offsets, which corresponds with the measured second value of the first SL relay. For example, the WTRU 102 may select the first cell, such as by evaluating the modified criterion S for the first cell. At 408, the WTRU 102 may send a RRC setup request message or a RRC resume request message via (e.g., to) a best cell.

In certain representative embodiments, the WTRU 102 may after receiving the RRC release message, perform discovery of any SL relays (e.g., the first SL relay).

In certain representative embodiments, the WTRU 102 may measure the second value which includes any of a SL radio quality for a SL relay interface (e.g., PC5 interface) associated with the first SL relay, a CBR for the SL relay interface associated with the first SL relay, and/or a CR for the SL relay interface associated with the first SL relay.

In certain representative embodiments, the WTRU 102 may measure the first value which includes a reference signal received power (RSRP) for the radio interface (e.g., direct Uu link) associated with the first cell.

In certain representative embodiments, the WTRU 102 may measure the first value includes a reference signal received quality (RSRQ) for the radio interface (e.g., direct Uu link) associated with the first cell.

In certain representative embodiments, the WTRU 102 may determine the offset from among the set of offsets based on (e.g., using) a function of the measured second value.

In certain representative embodiments, the WTRU 102 may determine the offset from among the set of offsets based on the function of the measured second value and any of a baseline offset, a maximum offset, a baseline value for the first SL relay, and/or a scaling factor.

In certain representative embodiments, the WTRU 102 may determine the offset from among the set of offsets based on a SL value range corresponding to the measured second value for the first SL relay. For example, each offset of the set of offsets may be associated with a respective SL value range or thresholds.

In certain representative embodiments, the WTRU 102 may select the first cell by modifying the measured first value using the determined offset. The modified first value may be used by the WTRU 102 to determine whether the cell selection criterion (e.g., criterion S) is fulfilled.

In certain representative embodiments, the information indicating the configuration of the set of offsets and/or the RRC release message may be received from a second cell different from the first cell.

In certain representative embodiments, the information indicating the configuration of the set of offsets is received in a RRC reconfiguration message.

For example, the information indicating the configuration of the set of offsets may be received in a RRC message, such as the RRC Release message or a RRC Reconfiguration message.

In certain representative embodiments, the first value, modified by the offset, of the first cell is a best value compared to one or more measured and/or modified values of one or more other cells. For example, the WTRU 102 may use the modified first value of the first cell and a measured value of another cell (e.g., which does not provide multipath operation). For example, the WTRU 102 may use the modified first value of the first cell and a modified value (e.g., modified using a respectively determined offset as described herein) of another cell (e.g., which provides multipath operation).

FIG. 5 is a procedural diagram illustrating an example procedure for cell ranking. For example, the procedure in FIG. 5 may be implemented by a WTRU 102 (e.g., a remote WTRU) for cell ranking. As shown at 502, a WTRU 102 may receive information indicating a configuration of a set of offsets associated with SL measurement values. At 504, the (e.g., remote) WTRU 102, after receiving a RRC release message (e.g., after the WTRU 102 is in RRC_Inactive or RRC_Idle), may measure (1) a first value of a radio interface associated with a first cell and (2) a second value of a first SL relay providing multipath connectivity to the first cell. For example, the first value may be a measurement of a radio interface which is a direct (e.g., Uu) link to the first cell. For example, the second value may be a measurement of a SL interface (e.g., associated with a relay WTRU) which is an indirect (e.g., PC5) link to the first cell. At 506, the WTRU 102 may rank a set of cells which includes the first cell. For example, the WTRU 102 may determine the set of cells as described herein, such as by evaluating the (e.g., modified) criterion S for a serving cell and one or more neighboring cells. For example, the first cell may be ranked using the measured first value which is modified by an offset, (e.g., determined) from the set of offsets, which corresponds with the measured second value of the first SL relay. At 510, the WTRU 102 may determine a best cell based on the ranked set of cells. At 512, the WTRU 102 may send a RRC setup request message or a RRC resume request message via (e.g., to) the best cell.

In certain representative embodiments, the first cell may be a serving cell of the WTRU 102.

In certain representative embodiments, the first cell may be a neighboring cell of the WTRU.

In certain representative embodiments, the WTRU 102 may after receiving the RRC release message, perform discovery of any SL relays (e.g., the first SL relay).

In certain representative embodiments, the WTRU 102 may measure the second value which includes any of a SL radio quality of a SL relay interface (e.g., PC5 interface) associated with the first SL relay, a channel busy ratio (CBR) of the SL relay interface (e.g., PC5 interface) associated with the first SL relay, and/or a channel occupation ratio (CR) of the SL relay interface associated with the first SL relay.

In certain representative embodiments, the WTRU 102 may measure the first value which includes a reference signal received power (RSRP) of the radio interface associated with the first cell.

In certain representative embodiments, the WTRU 102 may measure the first value which includes a reference signal received quality (RSRQ) of the radio interface associated with the first cell.

In certain representative embodiments, the WTRU 102 may determine the offset from among the set of offsets based on a function of the measured second value.

In certain representative embodiments, the WTRU 102 may determine the offset from among the set of offsets based on a function of the second value of the first SL relay and any of a baseline offset, a maximum offset, a baseline value for the first SL relay, and/or a scaling factor.

In certain representative embodiments, the WTRU 102 may determine the offset from among the set of offsets based on a SL value range corresponding to the measured second value for the first SL relay. For example, each offset of the set of offsets may be associated with a respective SL value range or thresholds.

In certain representative embodiments, the WTRU 102 may rank the set of cells based on modifying the measured first value of the radio interface using the determined offset. For example, the modified first value may be used by the WTRU 102 to rank the first cell among the set of cells.

In certain representative embodiments, the WTRU 102 may, after receiving the RRC release message, measure (3) a third value of a radio interface associated with a second cell. For example, the second cell may be included in the set of cells which are to be ranked at 508. For example, the measured third value may be used by the WTRU 102 to rank the second cell among the set of cells.

In certain representative embodiments, the WTRU 102 may, after receiving the RRC release message, measure (3) a third value of a radio interface associated with a second cell and (4) a fourth value of a second SL relay providing multipath connectivity to the second cell. For example, the second cell may be included in the set of cells which are to be ranked at 508. For example, the measured third value and the measured fourth value may be used by the WTRU 102 to rank the second cell among the set of cells. For example, the second cell may be ranked based on the measured third value of the radio interface, which is modified by an offset, (e.g., determined) from the set of offsets, which corresponds with the measured fourth value of the second SL relay. As an example, the measured third value may be modified by the offset which corresponds to the measured fourth value.

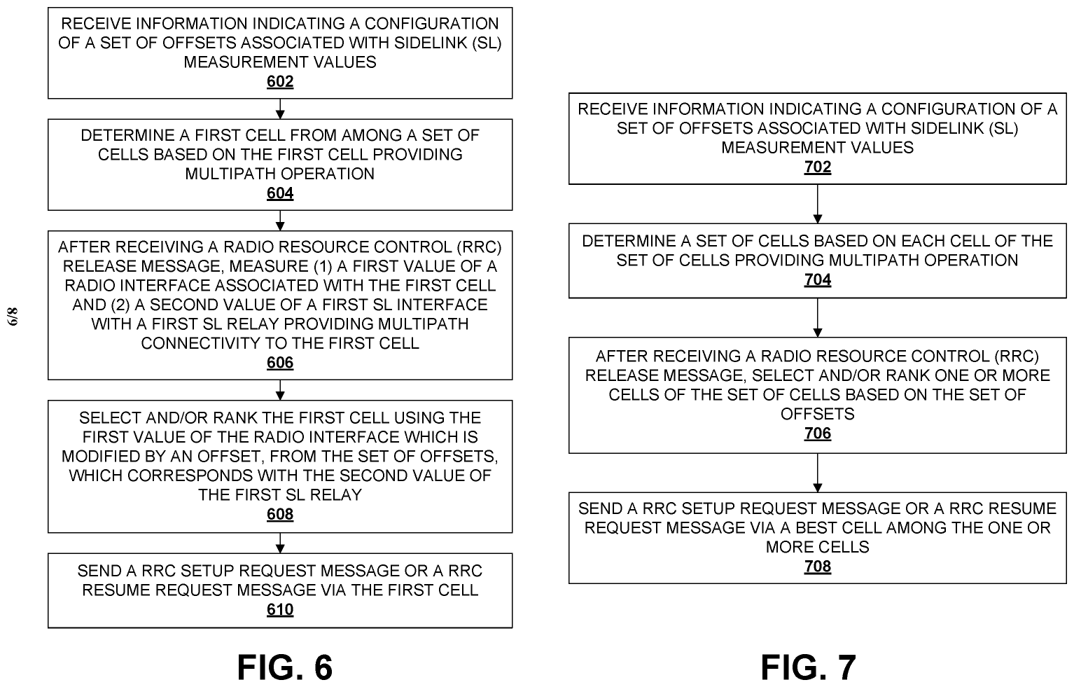

FIG. 6 is a procedural diagram illustrating an example procedure for cell selection and/or ranking based on multipath operation. For example, the procedure in FIG. 6 may be implemented by a WTRU 102 (e.g., a remote WTRU) for cell selection and/or ranking based on multipath operation. At 602, the WTRU 102 may receive information indicating a configuration of a set of offsets associated with SL measurement values. At 604, the WTRU may determine a first cell from among a set of cells based on the first cell providing multipath operation. At 606, the (e.g., remote) WTRU 102 may, after receiving a RRC release message (e.g., after the WTRU 102 is in RRC_Inactive or RRC_Idle), measure (1) a first value of a radio interface associated with the first cell and (2) a second value of a first SL interface with a first SL relay providing multipath connectivity to the first cell. For example, the first value may be a measurement of a radio interface which is a direct (e.g., Uu) link to the first cell. For example, the second value may be a measurement of a SL interface (e.g., associated with a relay WTRU) which is an indirect (e.g., PC5) link to the first cell. At 608, the WTRU 102 may select (e.g., reselect) and/or rank the first cell using the first value of the radio interface which is modified by an offset, (e.g., determined) from the set of offsets, which corresponds with the second value of the first SL relay. For example, the WTRU 102 may select (e.g., reselect) the first cell based on evaluating a modified criterion S (e.g., using the modified first value) as described herein. For example, the WTRU 102 may rank the first cell based on evaluating a modified criterion R (e.g., using the modified first value) as described herein. At 610, the WTRU may send a RRC setup request message or a RRC resume request message via (e.g., to) the first cell.

In certain representative embodiments, the set of cells may include one or more additional cells which provide multipath operation. In certain representative embodiments, the set of cells may include one or more cells which do not provide multipath operation.

In certain representative embodiments, the WTRU 102 may determine (e.g., at 604) a second cell from among the set of cells based on the second cell providing multipath operation. The WTRU 102 may, after receiving the RRC release message, measure (3) a third value of a radio interface associated with the second cell and (4) a fourth value of a second SL interface associated with a second SL relay providing multipath connectivity to the second cell (e.g., at 606). For example, the third value may be a measurement of a radio interface which is a direct (e.g., Uu) link to the second cell. For example, the fourth value may be a measurement of a SL interface (e.g., associated with a relay WTRU) which is an indirect (e.g., PC5) link to the second cell.

In certain representative embodiments, the WTRU 102 may select (e.g., reselect) and/or rank the second cell based on the measured third value for the radio interface, which is modified by an offset, (e.g., determined) from the set of offsets, which corresponds with the measured fourth value for the second SL interface. For example, the WTRU 102 may select (e.g., reselect) the first cell based on evaluating a modified criterion S (e.g., using the determined offset) as described herein. For example, the WTRU 102 may rank the first cell based on evaluating a modified criterion R (e.g., using the modified value of the first cell) as described herein. For example, the WTRU 102 may select (e.g., reselect) the first cell based on evaluating a modified criterion S (e.g., using the modified value of the first cell) and then perform ranking using a legacy criterion R. For example, the WTRU 102 may select (e.g., reselect) the first cell based on evaluating a legacy criterion S and then perform ranking using a modified criterion R (e.g., using the modified value of the first cell).

In certain representative embodiments, the WTRU 102 may send the RRC setup request message or the RRC resume request message (e.g., at 610) via the first cell based on the ranking of the first cell and the second cell (e.g., where the first cell is ranked higher than the second cell).

In certain representative embodiments, the WTRU 102 may rank the first cell above the second cell (e.g., above all other cells in the set of cells) based on the measured first value which has been modified by the respectively determined offset (e.g., which corresponds to the measured second value) being higher than the measured third value which is modified by the respectively determined offset (e.g., which corresponds to the measured fourth value).

In certain representative embodiments, the WTRU 102 may select (e.g., reselect at 608) the first cell based on the measured first value which has been modified by the offset (e.g., which corresponds with the measured second value).

In certain representative embodiments, the WTRU 102 may rank (e.g., at 608) the first cell based on the measured first value which is modified by the offset (e.g., which corresponds with the measured second value).

In certain representative embodiments, the WTRU 102 may determine (e.g., at 604) the first cell from among the set of cells based on the first cell providing multipath operation after receiving the RRC release message.

FIG. 7 is a procedural diagram illustrating another example procedure for cell selection and/or ranking based on multipath operation. For example, the procedure in FIG. 7 may be implemented by a WTRU 102 (e.g., a remote WTRU) for cell selection and/or ranking based on multipath operation. At 702, the WTRU 102 may receive information indicating a configuration of a set of offsets associated with SL measurement values. At 704, the (e.g., remote) WTRU 102 may determine a set of cells based on each cell of the set of cells providing multipath operation. For example, the set of cells may include a first cell providing multipath (e.g., via a first relay WTRU) and a second cell providing multipath operation (e.g., via a second relay WTRU). At 706, the WTRU 102 may, after receiving a RRC release message, select (e.g., reselect) and/or rank one or more cells of the set of cells based on the set of offsets. For example, the WTRU 102 may determine a first offset from among the set of offsets which may apply for a first cell among the set of cells (e.g., based on measurements associated with the first cell). The first offset may be used to modify the measurement of the first cell. For example, the WTRU 102 may determine a second offset from among the set of offsets which may apply for a second cell among the set of cells (e.g., based on measurements associated with the second cell). The second offset may be used to modify the measurement of second first cell. At 708, the WTRU 102 may send a RRC setup request message or a RRC resume request message via (e.g., to) a best cell among the one or more cells.

In certain representative embodiments, the WTRU 102 may (e.g., at 706) select (e.g., reselect) the set of cells based on evaluating a modified criterion S (e.g., using the determined offset as a modifier) as described herein.

In certain representative embodiments, the WTRU 102 may (e.g., at 706) rank the set of cells based on evaluating a modified criterion R (e.g., using the determined offset as a modifier) as described herein.

In certain representative embodiments, the WTRU 102 may (e.g., at 706) select (e.g., reselect) set of cells based on evaluating a modified criterion S (e.g., using the determined offset as a modifier) and then perform ranking of the set of cells using a legacy criterion R.

In certain representative embodiments, the WTRU 102 may (e.g., at 706) select (e.g., reselect) the set of cells based on evaluating a legacy criterion S and then perform ranking of the set of cells using a modified criterion R (e.g., using the determined offset as a modifier).

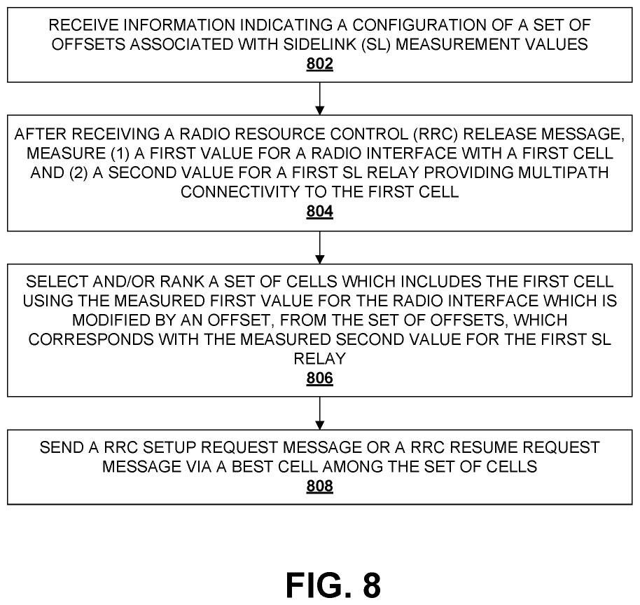

FIG. 8 is a procedural diagram illustrating an example procedure for cell selection and/or ranking a first cell among a set of cells. For example, the procedure in FIG. 8 may be implemented by a WTRU 102 (e.g., a remote WTRU) for cell selection and/or ranking a first cell among a set of cells. At 802, a WTRU 102 may receive information indicating a configuration of a set of offsets associated with SL measurement values. At 804, the (e.g., remote) WTRU 102 may, after receiving a RRC release message, measuring (1) a first value for a radio interface with a first cell and (2) a second value for a first SL relay providing multipath connectivity to the first cell. For example, the first value may be a measurement of a radio interface which is a direct (e.g., Uu) link to the first cell. For example, the second value may be a measurement of a SL interface (e.g., associated with a relay WTRU) which is an indirect (e.g., PC5) link to the first cell. At 806, the WTRU 102 may select (e.g., reselect) and/or rank a set of cells which includes the first cell. The selecting and/or ranking of the first cell may use the measured first value for the radio interface which is modified by an offset, (e.g., determined) from the set of offsets, which corresponds with the measured second value for the first SL relay. At 808, the WTRU 102 may send a RRC setup request message or a RRC resume request message via (e.g., to) a best cell among the set of cells.

In certain representative embodiments, the WTRU 102 may select (e.g., reselect), at 806, the first cell based on evaluating a modified criterion S (e.g., using the determined offset as a modifier) as described herein.

In certain representative embodiments, the WTRU 102 may rank, at 806, the first cell based on evaluating a modified criterion R (e.g., using the determined offset as a modifier) as described herein.

In certain representative embodiments, the WTRU 102 may select (e.g., reselect) the first cell based on evaluating a modified criterion S (e.g., using the determined offset as a modifier) and then perform ranking using a legacy criterion R at 806.

In certain representative embodiments, the WTRU 102 may select (e.g., reselect) the first cell based on evaluating a legacy criterion S and then perform ranking using a modified criterion R (e.g., using the determined offset as a modifier) at 806.

In certain representative embodiments, the WTRU 102 may receive, from the first SL relay, broadcast information indicating that the first SL relay provides multipath connectivity to the first cell.

In certain representative embodiments, the WTRU 102 may send (e.g., broadcast) a solicitation message. The WTRU 102 may receive, from the first SL relay, information indicating that the first SL relay provides multipath connectivity to the first cell.

In certain representative embodiments, the WTRU 102 may measure (1) the first value and (2) the second value at 804 based on a determination that the first cell provides multipath operation and/or the first SL relay provides multipath connectivity to the first cell. For example, the WTRU 102 may prioritize the selection and/or ranking of cells providing multipath operation.

In certain representative embodiments, the WTRU 102 may rank, at 806, the set of cells based on a determination that the first cell provides multipath operation and/or the first SL relay provides multipath connectivity to the first cell. For example, the WTRU 102 may prioritize the first cell in the ranking of the set of cells based on first cell providing multipath operation.

In certain representative embodiments, the best cell at 808 may be the first cell. For example, the best cell may be the first cell, such as when the first cell has a highest ranking among the set of cells.

In certain representative embodiments, the WTRU 102 may determine the offset from among the set of offsets based on a function of the measured second value for the first SL relay.

In certain representative embodiments, the WTRU 102 may determine the offset based on a function of the measured second value for the first SL relay and any of a baseline offset, a maximum offset, a baseline value for the first SL relay, and/or a scaling factor.

In certain representative embodiments, the WTRU 102 may determine the offset from among the set of offsets based on a SL value range corresponding to the measured second value for the first SL relay. For example, each offset of the set of offsets may be associated with a respective SL value range or thresholds.

In certain representative embodiments, the WTRU 102 may select and/or rank the first cell using the measured first value which is modified using the determined offset.

In certain representative embodiments, the WTRU 102 may, after receiving the RRC release message, measure (e.g., at 804) (3) a third value for a radio interface with a second cell which is included in the set of cells. For example, the WTRU 102 may rank the second cell based on the measured third value. For example, the second cell may not provide multipath operation.

In certain representative embodiments, the WTRU 102 may, after receiving the RRC release message, measure (e.g., at 804) (3) a third value for a radio interface associated with a second cell, which is included in the set of cells, and (4) a fourth value for a second SL relay providing multipath connectivity to the second cell. For example, the second cell may be selected and/or ranked at 806 based on the measured third value for the radio interface, which is modified by another offset, determined from the set of offsets, which corresponds with the measured fourth value for the second SL relay. For example, each of the first and second cells may be selected and/or ranked (e.g., after modification of measurements using respective offsets) as described herein.

In certain representative embodiments, a method may be implemented by a WTRU 102 (e.g., a remote WTRU) that includes determining one or more cells which provide multipath operation. The WTRU 102 may receive a connection release message (e.g., a RRC release message) from a network. The WTRU 102 may select a first cell from among the one or more cells which provide multipath operation. For example, the selection of the first cell may include measuring one or more cell attributes of the first cell, and determining whether one or more cell selection conditions are satisfied based on (1) the measured one or more signal attributes of the first cell and (2) one or more signal attributes of a relay WTRU associated with the multipath operation provided by the first cell.

For example, the WTRU 102 may be camped on the selected first cell.

For example, the connection release message includes information indicating an inactive radio network temporary identifier (I-RNTI).

For example, the connection release message may be received before, or after, the determining of the one or more cells which provide multipath operation.

For example, the WTRU 102 may receive system information associated with the first cell. The WTRU 102 may determine whether the one or more cell selection conditions are satisfied based on (1) the measured one or more signal attributes of the first cell, (2) the one or more signal attributes of the relay WTRU, and (3) information indicated in the received system information.

For example, the WTRU 102 may select the first cell based on determining one or more offset values to apply to the one or more signal attributes of the first cell using the one or more signal attributes of the relay WTRU.

For example, the WTRU 102 may select the first cell based on determining one or more offset values to apply to the one or more signal attributes of the first cell using the one or more signal attributes of the relay WTRU and one or more threshold values.

For example, the one or more signal attributes of the relay WTRU may include any of a sidelink (SL) radio quality, a channel busy ratio (CBR), and/or a channel occupation ratio (CR) which are associated with the relay WTRU.

For example, the WTRU 102 may select the relay WTRU from among a plurality of relay WTRUs associated with the first cell.

For example, the one or more selection conditions may include any of a cell selection reception level value being greater than a respective threshold and/or a cell selection quality value being greater than a respective threshold.

In certain representative embodiments, a method may be implemented by a WTRU 102 (e.g., a remote WTRU) that includes determining one or more neighbor cells which provide multipath operation. The WTRU 102 may receive a connection release message (e.g., RRCRelease) from a network. The WTRU 102 may select a first cell from among the one or more neighbor cells which provide multipath operation and a serving cell. For example, the selection of the first cell may include measuring one or more cell attributes of each of the serving cell and the one or more neighbor cells, and determining one or more cells among the serving cell and the neighbor cells which each satisfy one or more cell selection conditions based on (1) the measured one or more signal attributes of each of the serving cell and the one or more neighbor cells and (2) one or more signal attributes of respective relay WTRUs associated with multipath operation provided by any (e.g., each) of the serving cell and the one or more neighbor cells. The WTRU 102 may select a best cell (e.g., the first cell) based on a ranking of the one or more cells.

For example, the WTRU 102 may be camped on the selected first cell.

For example, the connection release message may include information indicating an inactive radio network temporary identifier (I-RNTI).

For example, the connection release message may be received before, or after, the determining of the one or more cells which provide multipath operation.

For example, the WTRU 102 may receive system information. The WTRU 102 may determine whether the one or more cell selection conditions are satisfied based on (1) the measured one or more signal attributes of the first cell, (2) the one or more signal attributes of the respective relay WTRUs, and (3) information indicated in the received system information.

For example, the WTRU 102 may select the first cell based on determining one or more offset values to apply to the measured one or more signal attributes using the one or more signal attributes of the respective relay WTRUs.

For example, the WTRU 102 may select the first cell based on determining one or more offset values to apply to the measured one or more signal attributes using the one or more signal attributes of the respective relay WTRUs and one or more threshold values.

For example, the one or more signal attributes of a relay WTRU may include any of a sidelink (SL) radio quality, a channel busy ratio (CBR), and/or a channel occupation ratio (CR) which are associated with the respective relay WTRU.

For example, the WTRU 102 may select the respective relay WTRUs from among a plurality of relay WTRUs associated with the serving cell and the one or more neighbor cells.

For example, the one or more selection conditions may include any of a cell selection reception level value being greater than a respective threshold and/or a cell selection quality value being greater than a respective threshold.

For example, the WTRU 102 may rank the one or more cells based on any of a reference signal received power quantity (RSRP) for cell reselection, a first offset value, and/or a temporary offset value.

For example, the WTRU 102 may establish a sidelink (SL) connection with the relay WTRU which is associated with multipath operation provided by the first cell.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented by a wireless/transmit receive unit (WTRU), the method comprising:
receiving information indicating a configuration of a set of offsets associated with sidelink (SL) measurement;
after receiving a radio resource control (RRC) release message, measuring (1) a first value of a radio interface associated with a first cell and (2) a second value of a first SL relay providing multipath connectivity to the first cell;
selecting the first cell based on the first value and an offset, determined from the set of offsets, which corresponds with the second value of the first SL relay; and
sending a RRC setup request message or a RRC resume request message via a best cell.

2. The method of claim 1, wherein the second value includes a SL radio quality of a SL relay interface associated with the first SL relay.

3. The method of claim 1, wherein the second value incudes a channel busy ratio (CBR) of a SL relay interface associated with the first SL relay and/or a channel occupation ratio (CR) of the SL relay interface associated with the first SL relay.

4. The method of claim 1, wherein the first value includes a reference signal received power (RSRP) of the radio interface associated with the first cell and/or a reference signal received quality (RSRQ) of the radio interface associated with the first cell.

5. (canceled)

6. The method of claim 1, further comprising:
determining the offset from among the set of offsets based on a function of the second value.

7. (canceled)

8. The method of claim 1, further comprising:
determining the offset from among the set of offsets based on a SL value range corresponding to the second value of the first SL relay,
wherein each offset of the set of offsets is associated with a respective SL value range.

9. The method of claim 1, wherein the selecting of the first cell includes:
modifying the first value using the offset.

10. The method of claim 1, wherein the information indicating the configuration of the set of offsets and/or the RRC release message are received from a second cell different from the first cell.

11. The method of claim 1, wherein the information indicating the configuration of the set of offsets is received in a RRC reconfiguration message.

12. The method of claim 1, wherein the best cell is the first cell.

13. A wireless transmit/receive unit (WTRU) comprising:
a processor and a transceiver which are configured to:
receive information indicating a configuration of a set of offsets associated with sidelink (SL) measurement,
after reception of a radio resource control (RRC) release message, measure (1) a first value of a radio interface associated with a first cell and (2) a second value of a first SL relay providing multipath connectivity to the first cell,
select the first cell based on the first value and an offset, determined from the set of offsets, which corresponds with the second value of the first SL relay, and
send a RRC setup request message or a RRC resume request message via the selected cell.

14. The WTRU of claim 13, wherein the second value includes a SL radio quality of a SL relay interface associated with the first SL relay.

15. The WTRU of claim 13, wherein the second value incudes a channel busy ratio (CBR) of a SL relay interface associated with the first SL relay and/or a channel occupation ratio (CR) of the SL relay interface associated with the first SL relay.

16. The WTRU of claim 13, wherein the first value includes a reference signal received power (RSRP) of the radio interface associated with the first cell and/or a reference signal received quality (RSRQ) of the radio interface associated with the first cell.

17. (canceled)

18. The WTRU of claim 13, wherein the processor and the transceiver are further configured to:
determine the offset from among the set of offsets based on a function of the second value.

19. (canceled)

20. The WTRU of claim 13, wherein the processor and the transceiver are further configured to:
determine the offset from among the set of offsets based on a SL value range corresponding to the second value of the first SL relay, and
wherein each offset of the set of offsets is associated with a respective SL value range.

21. The WTRU of claim 13, wherein the processor and the transceiver are further configured to select the first cell which includes to:
modify the first value of the radio interface using the offset.

22. The WTRU of claim 13, wherein the information indicating the configuration of the set of offsets and/or the RRC release message are received from a second cell different from the first cell.

23. The WTRU of claim 13, wherein the information indicating the configuration of the set of offsets is received in a RRC reconfiguration message.

24. The WTRU of claim 13, wherein the best cell is the first cell.
